(19) United States
(12) Patent Application Publication
(10) Pub. No.: US 2003/0006659 A1
(43) Pub. Date: Jan. 9, 2003

(54) Ball bearing fixed assembly in a direct current fan

(76) Inventor: Chin Ching Yeh, Kaohsiung (TW)

Correspondence Address: Connolly Bove Lodge & Hutz LLP, P.O. Box 2207, Wilmington, DE, 19899-2207, US

(21) Appl. No.: 09/991,405

(22) Filed: Nov. 14, 2001

(30) Foreign Application Priority Data
Jul. 9, 2001 (TW) 90215447

(51) Int. Cl. H02K 5/16; H02K 7/08

(52) U.S. Cl. 310/90

(57) ABSTRACT

A ball bearing fixed assembly in a direct current fan comprises a fan blade unit, a motor unit, and a fan base. The fan blade unit has an integral fan blade, a spindle at the lower central position thereof, a motor casing at an inner side of the fan blade, and a magnet bar that are attached to an inner side of the casing. The motor unit has an insulation frame, silicon steel sheets, a circuit board and coils. The silicon steel sheets horizontally surround the insulation frame, the circuit board is disposed below the insulation frame, and the coils are perpendicular to the silicon steel sheets and mounted within the insulating frame. A ball bearing is installed in a central position within the fan base and fits with the spindle. An oil chamber is disposed below the ball bearing with a first receiving room and a second receiving room. The second receiving room is disposed above the first receiving room. The spindle has the lower end thereof extending into the first receiving room, which has filled with lubrication oil. A retaining ring is attached to the spindle at a position above the first receiving room. A spring surrounds the axis and is arranged between the retaining ring and the ball bearing.

### BACKGROUND OF THE INVENTION

1. Field of the Invention

The present invention relates to a ball bearing fixed assembly in a current fan, particularly to a ball bearing fixed assembly, which makes the ball bearing be located in the direct current fan steadily and has a simple structure with low production and material costs and low noise, and with a long durability.

2. Description of Related Art

Nowadays, computers are essential tools for personal individuals as well as for companies. An important feature of every computer is the speed of the central processing unit (CPU) thereof. However, the higher the speed, the more heat is produced. As a result, it possibly leads to a state of excessive high temperature and damages the CPU or chips in the computer. For dissipating heat effectively, the CPU usually carries a radiator and a fan.

A conventional fan, as shown in FIG. 1, comprises a fan blade unit 10′, a motor unit 20′ and a fan base 30′. The motor unit 20′ is mounted on the fan base 30′, and the fan blade unit 10′ is attached to a spindle seat 31′ of the fan base 30′ via a spindle 12′. The spindle 12′ is surrounded by an oil sealing ring 36a′, a ball bearing 32′, an oiled bearing 35′, an oil sealing ring 36b′, and a retaining ring 34′ such that the noise and the vibration caused by only the ball bearing 32′ being installed can be prevented during the fan blade unit 10′ rotating along with the spindle 12′. However, using two bearings increases the material and the production costs as well as labor hours. Furthermore, the ball bearing 32′ and the oiled bearing 35′ are unable to obtain sufficient lubrication such that it is possible to become out of order and have a reduced lifetime after a long period of running.

### SUMMARY OF THE INVENTION

It is the main object of the present invention to provide a ball bearing fixed assembly in a direct current fan, in which the fixed assembly is composed of an oil chamber, a retaining ring, a spring, and an oiled bearing with a simple structure for saving the production and the material costs and lowering down the labor hours.

Another object of the present invention is to provide a ball bearing fixed assembly in a direct current fan, in which a ball bearing can be tightly attached to the spindle seat against a spring and an oil chamber to reduce the vibration and to prolong the life span thereof.

A further object of the present invention is to provide a ball bearing fixed assembly in a direct current fan, in which a large quantity of oil is stored in an oil chamber to ensure a spindle thereof obtaining sufficient lubrication with little noise and long durability.

### BRIEF DESCRIPTION OF THE DRAWINGS

The present invention can be more fully understood by reference to the following description and accompanying drawings, in which:

FIG. 1 is a sectional view of a conventional ball bearing fixed assembly in a direct current fan; and

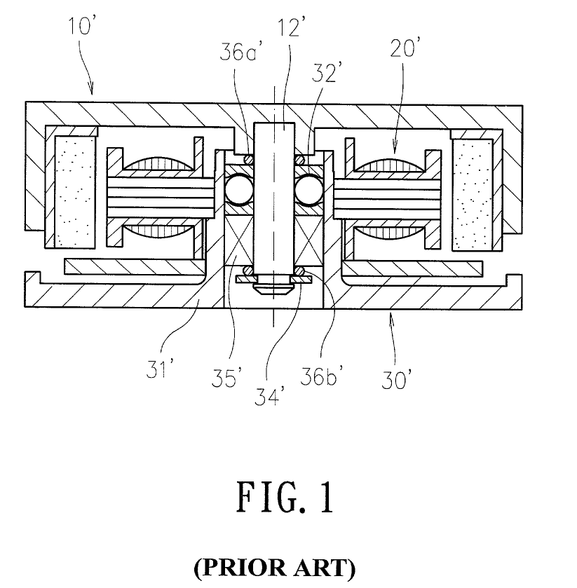

FIG. 2 is a sectional view of a ball bearing fixed assembly in a direct current fan.

### DETAILED DESCRIPTION OF THE PREFERRED EMBODIMENT

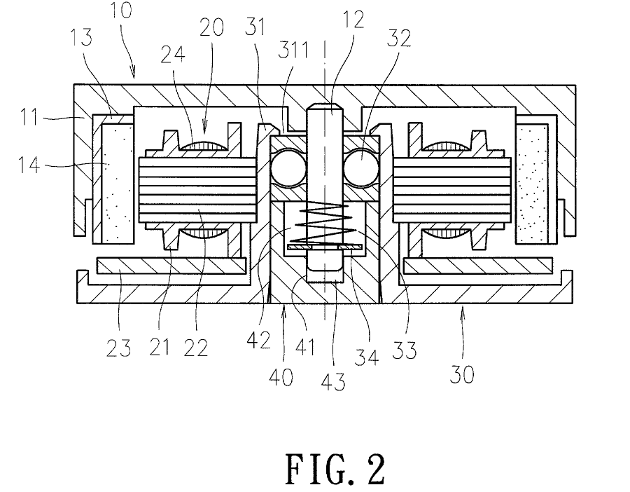

As shown in FIG. 2, a ball bearing fixed assembly in a direct current fan of the present invention mainly comprises a fan blade unit 10, a motor unit 20, and a fan base 30. The motor unit 20 is mounted on the fan base 30, and the fan blade unit 10 is attached to the motor unit 20 and the fan base 30 by way of a spindle 12 so that the ball bearing fixed assembly can be provided with an integral structure.

The fan blade unit 10 has an integral fan blade 11, a spindle 12, a motor casing 13 and a magnet bar 14. The spindle 12 is placed at a lower side of the fan blade 11 in a central position thereof. The motor casing 13 is mounted to a lower peripheral inner side of the fan blade 11. The magnet bar 14 is attached to an inner side of the casing 13.

The motor unit 20 has an insulation frame 21, silicon steel plates 22, a circuit board 23 and coils 24. The silicon steel plates 22 horizontally surround the insulation frame 21. The coils 24 are disposed perpendicular to the silicon plates 22 and mounted within the insulation frame 21. The circuit board 23 is located between a lower side of the insulation frame 21 and the fan base 30.

A spindle seat 31 is provided in a central position within the base 30. A ball bearing 32 fits with the spindle 12 and is adjacent to the spindle seat 31 and an oil chamber 40 is arranged in the spindle seat 31 below the ball bearing 32. The oil chamber 40 has a first receiving room 41 and a second receiving room 42, and the second receiving room is disposed above the first receiving room 41. The spindle 12 has a lower end extending into the first receiving room 41, which has filled with sufficient lubrication oil 43. A retaining ring 34 is attached to the spindle 12 at a position above the first receiving room 41. A spring 33, which surrounds the spindle 12, is arranged between the retaining ring 34 and the ball bearing 32.

It is appreciated from the foregoing that the present invention offers the following advantages:

1. Simple structure with few component parts, saving the production and the material costs as well as the labor hours.

2. The ball bearing 32 is tightly attached to the spindle seat 31 against the spring 33 and the oil chamber 40 such that the vibration can be reduced and the life span of the ball bearing can be prolonged substantially.

3. A large quantity of oil can be maintained in the oil chamber 40 with least volatilization so that the spindle can obtain sufficient lubrication with less noise during running and the component parts in the direct current fan can provide a longer life span effectively.

While the invention has been described with reference to a preferred embodiment thereof, it is to be understood that modifications or variations may be easily made without departing from the spirit of this invention which is defined by the appended claims.

What is claimed is:

1. A ball bearing fixed assembly, comprising:
a fan blade unit, further comprising an integral fan blade, a spindle, a motor casing, and a magnet bar, the spindle being mounted at a lower central position, the motor casing being mounted at a peripheral inner side of said fan blade, and the magnet bar being attached to an inner side of said motor casing;
a motor unit, further comprising an insulation frame, a plurality of silicon steel plates, a circuit board, and a plurality of coil, the silicon steel plates horizontally surrounding said insulation frame, the coils being mounted within said insulating frame, and the circuit board being located under a lower side of said insulation frame; and
a fan base, being disposed under the circuit board providing a spindle seat at a central position thereof to receive the spindle, a ball bearing fitting with the spindle above the spindle seat, an oil chamber being placed below said ball bearing with a first receiving room and a second receiving room, the second receiving room being disposed above the first receiving room, said spindle having a lower end extending into said first receiving room, the first receiving room having sufficient amount of lubrication oil, a retaining ring being attached to said spindle above said first receiving room, and a spring surrounding said spindle and being located between said retaining ring and said ball bearing;
wherein, the ball bearing is tightly attached within the spindle seat against the spring and the oil chamber.
